(19) United States
(12) Patent Application Publication
(10) Pub. No.: US 2023/0244703 A1
(43) Pub. Date: Aug. 3, 2023

(54) TEXT DATA ATTRIBUTION DESCRIPTION AND GENERATION METHOD BASED ON TEXT CHARACTER FEATURES

(71) Applicants: COMMUNICATION UNIVERSITY OF ZHEJIANG, Hangzhou (CN); Communication University of Zhejiang Tongxiang Research Institute Co., Ltd, Jiaxing (CN)

(72) Inventors: Qingsheng LI, Hangzhou (CN); Li ZHANG, Hangzhou (CN); Zhiqiang LUO, Hangzhou (CN); Xuemei WANG, Hangzhou (CN); Li ZHANG, Wuhan (CN); Guili TAO, Hangzhou (CN); Li CHEN, Hangzhou (CN); Jun ZHENG, Hangzhou (CN); Weifeng YIN, Hangzhou (CN); Shuping QIU, Hangzhou (CN)

(73) Assignees: COMMUNICATION UNIVERSITY OF ZHEJIANG, Hangzhou (CN); Communication University of Zhejiang Tongxiang Research Institute Co., Ltd, Jiaxing (CN)

(21) Appl. No.: 18/295,185

(22) Filed: Apr. 3, 2023

Related U.S. Application Data
(63) Continuation of application No. PCT/CN2022/107220, filed on Jul. 22, 2022.

(30) Foreign Application Priority Data
Sep. 7, 2021 (CN) 202111041957.7

(51) Int. Cl. G06F 16/31; G06F 16/387; G06F 16/383

(52) U.S. Cl. CPC G06F 16/313; G06F 16/387; G06F 16/383

(57) ABSTRACT

Disclosed is a text data attribution description and generation method based on text character features, comprising: obtaining text data to be processed, decomposing the text data to obtain a plurality of characters, and performing a feature space representation on the text data based on the characters; storing the features of the text data through a horizontal position of the characters and an association between different characters according to the feature space representation of the text data; generating a text data attribution according to feature storage results of the text data.

### CROSS-REFERENCE TO RELATED APPLICATIONS

This application is a continuation of International Application No. PCT/CN2022/107220, filed on Jul. 22, 2022, and claims priority to Chinese Patent Application No. 202111041957.7, filed on Sep. 7, 2021, the entire contents of which are incorporated herein by reference.

### TECHNICAL FIELD

The application relates to the technical field of text data attribution generation, and in particular to a text data attribution description and generation method based on text character features.

### BACKGROUND

Nowadays, when intelligent technology has entered the content industry in an all-round way, the content generation and distribution in content-related industries, especially the news industry, are being redefined, and data has become the core content of information management and service. Because of the convenience of text data in information editing, copying, dissemination and storage, it rapidly becomes the main technology and means for all kinds of media to carry out automatic production, management, operation and service. In September 2015, Tencent Finance launched the automated news writing robot “Dreamwriter”, which took one minute to write the first report; in November, Xinhua News Agency's manuscript writing machine “Kuaibi Xiaoxin” officially took up its post, and can write Chinese and English manuscripts and financial information drafts of sports events; in 2016, the news writing robot “Zhang Xiaoming”, jointly developed by Today's Headline Lab and Peking University Computer Research Institute (Wan Xiaojun team), wrote a total of 457 event reports in 13 days, and it took only 0.3 seconds to write a simple newsletter press release during the peak period; on Nov. 7, 2018, in the 5th world internet conference, Sogou cooperated with Xinhua News Agency to develop the world's first “AI composite anchor”, and the essence of writing robot and AI synthesis anchor is automatic text production based on intelligent technology and algorithms.

While enjoying the technical convenience, data security has also become an important issue. Once the writing robot or synthetic anchor receives wrong information or rumors when capturing data, it will inevitably lead to public opinion crisis and even social panic. In the era of big data, intelligent content production technology improves the difficulty of information screening, so how to judge the data source, determine the data ownership and identify the true and false data has become an issue of concern. Therefore, it is necessary to provide a text data attribution description and generation method based on text character features, which may provide new ideas for solving data security problems through the concept of data fingerprint.

### SUMMARY

The objective of this application is to provide a text data attribution description and generation method based on text character features, so as to solve the problems in the prior art. The method may effectively generate text data attribution through the quantization matrix of feature space, solve the problems of automatic text generation and attribution management, enrich the basic theory and algorithm of natural language processing based on Chinese, provide a new idea for solving data security problems, and further provide theoretical and technical support for scientific management of future text big data.

To achieve the above objective, the application provides the following scheme.

The application provides a text data attribution description and generation method based on text character features, including:

obtaining text data to be processed, decomposing the text data to obtain a plurality of characters, and performing a feature space representation on the text data based on the characters;

storing the features of the text data through a horizontal position of the characters and an association between different characters according to the feature space representation of the text data;

generating a text data attribution according to feature storage results of the text data.

Optionally, a method for performing the feature space representation on the text data based on the characters includes the following steps:

each character in the text data is represented to be a function which takes a field, a character position and the number of feature points as variables, that is, a first feature point position function;

obtaining a second feature point position function of each character in the whole text data according to the feature point position function of each character;

performing the feature space representation according to the second feature point position function.

Optionally, the first feature point position function, the second feature point position function and the feature space T representation of the text data are respectively shown in formulae 1-3:

$$\begin{matrix}{f}_{q} ( {x}_{ij} , {y}_{ij} ) q ∈ Q & 1 \\ f ( {x}_{ij} , {y}_{ij} ) & 2 \\ T = {⋃}_{i = 1}^{n} {⋃}_{j = 1}^{{m}_{i}} f ( {x}_{ij} , {y}_{ij} ) & 3\end{matrix}$$

where (x_{y}, y_{y}) is position coordinates of the jth feature point of the ith character, Q is the number of fields in the text data, n is the number of characters in the text data, and mᵢ is the number of feature points of the ith character; the union set

$${⋃}_{j = 1}^{{m}_{i}}$$

of j from 1 to mᵢ represents the sum of mᵢ feature points in the feature space of the ith character.

Optionally, when the number n of characters in the text data tends to infinity, the feature space expression T′ of the text data is shown in Formula 4:

$${T}^{′} = {lim}_{n \to ∞} {⋃}_{i = 1}^{n} {⋃}_{j = 1}^{{m}_{i}} f ( {x}_{ij} , {y}_{ij} ) \qquad 4$$

where T′ is used to represent the feature space of text data of big data.

Optionally, the X matrix X_{n×m} is used to store X coordinates of each character in the text data, as shown in Formula 6:

$${X}_{n \times m} = [ \begin{matrix}{x}_{11} , {x}_{12} , ⋯ , {x}_{1 k} , ⋯ , {x}_{1 {m}_{1}} \\ {x}_{21} , {x}_{22} , ⋯ , {x}_{2 k} , ⋯ , {x}_{2 {m}_{2}} \\ ⋯⋯⋯⋯⋯⋯⋯⋯⋯ \\ {x}_{n 1} , {x}_{n 2} , ⋯ , {x}_{nk} , ⋯ , {x}_{{nm}_{n}}\end{matrix} ] \qquad 6$$

the Y matrix Y_{n×m} is used to store the y coordinates of each character in the text data, as shown in Formula 7:

$${Y}_{n \times m} = [ \begin{matrix}{y}_{11} , {y}_{12} , ⋯ , {y}_{1 k} , ⋯ , {y}_{1 {m}_{1}} \\ {y}_{21} , {y}_{22} , ⋯ , {y}_{2 k} , ⋯ , {y}_{2 {m}_{2}} \\ ⋯⋯⋯⋯⋯⋯⋯⋯⋯ \\ {y}_{n 1} , {y}_{n 2} , ⋯ , {y}_{nk} , ⋯ , {y}_{{nm}_{n}}\end{matrix} ] \qquad 7$$

the Z matrix Z_{n×q} is used to store the association between characters of the text data, as shown in Formula 8:

Z_{n×q}=[z₁,z₂, . . . ,z_{q}] 8

in the formula, xₙₘ_{ₙ} and yₙₘ_{ₙ} are respectively the x coordinate and y coordinate of the mₙth feature point of the nth character in the text data; n is the number of characters in the text data; q is the qth field in the text data; z_{q} is the association between characters in the qth field.

Optionally, the generated text data attribution is shown in Formula 9:

f_{Q}(x_{y},y_{y})=X_{n×m}\vec{i}+Y_{n×m}\vec{j}+Z_{n×q}\vec{k} 9

where f_{Q}(x_{y}, y_{y}) is the attribution of text data, and \vec{i}, \vec{j} and \vec{k} are the feature vectors of coordinate axes corresponding to X matrix, Y matrix and Z matrix, respectively.

The application discloses the following technical effects.

The application provides a text data attribution description and generation method based on text character features, which decomposes the text data to be processed into characters, performs feature space representation on the text data based on the characters, stores the features of the text data through the horizontal position of the characters and the association between different characters, and generates the text data attribution according to the feature storage results; the application develops a text space representation model based on Chinese character features, takes the description of text features as the main quantitative basis for generating text data attribution, and puts forward a method for generating text data attribution through the quantization matrix of feature space. The generated text data attribution will not be lost due to data attribution chain breaking, the data features will not be modified, and will not be lost because of secondary editing or processing, which contributes to solve the problems of automatic text generation and attribution management, and may enrich the basic theories and algorithms of Chinese-based natural language processing, provide a new idea for solving data security problems, thus providing theoretical and technical support for the scientific management of text big data in the future. In the current era of big data, data management is changing from “user-oriented” to “content-oriented”. It is of great significance to generate the attribution of isolated texts in the vast ocean of data, which lays a solid foundation for the development of independent and controllable Chinese information processing technology tools, equipment and technical means.

### BRIEF DESCRIPTION OF THE DRAWINGS

In order to more clearly explain the embodiments of this application or the technical solutions in the prior art, the following will briefly introduce the drawings needed in the embodiments. Obviously, the drawings in the following description are only some of the embodiments of this application. For those of ordinary skill in this field, other drawings may be obtained according to these drawings without any creative labor.

FIG. 1 is a flow chart of text data attribution description and generation method based on text character features in the embodiment of the present application.

FIG. 2 is a feature space representation schematic diagram of each character in the embodiment of the present application.

FIG. 3 is a schematic diagram of feature storage of the text data in the embodiment of the present application.

FIG. 4 is an example of abstract structure description of numbers and characters in the embodiment of this application.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. Based on the embodiment of the present application, all other embodiments obtained by ordinary technicians in the field without creative labor are within the scope of the present application.

In order to make the above objectives, features and advantages of the present application more obvious and understandable, the present application will be explained in further detail below with reference to the drawings and detailed description.

It should be noted that the embodiments in this application and the features in the embodiments may be combined with each other without conflict. The application will be described in detail with reference to the drawings and embodiments.

It should be noted that the steps shown in the flowcharts of the drawings may be executed in a computer system such as a set of computer-executable instructions, and, although a logical sequence is shown in the flowchart, in some cases, the steps shown or described may be executed in a sequence different from that here.

Usually, the data and the person or machine that generates the data are determined by the “attribution chain” established under a certain mechanism. This “attribution chain” may be managed by identifying the account number, the title and content of the data, etc. However, for news texts written by robots with only dozens to hundreds of Chinese characters, it is often difficult to find the original attribution of these data once the data attribution chain is broken, or some data features are modified, or after secondary editing or processing, due to the dynamic and sparse nature of text character data representing natural language, which brings difficulties to text data management. In order to solve this problem, domestic and foreign research institutions and scholars have put forward many solutions. For example, in order to recognize and protect the ownership of copyright and information content, Founder Company once developed a set of personal Weibo special glyphs for a famous actor in China to clarify the ownership of data information. Founder also developed a Microsoft-specific MHei font in Windows system to realize the recognition and protection of copyright. Google has not stopped supporting data specialization, personalized presentation and customized services for many years. Google's Web font project is very popular in English-speaking countries such as Europe and America. By designing its own exclusive fonts for personalized publishing, the copyright has been protected to the greatest extent. At present, Google has not launched a Web font project based on Chinese characters. The emergence of writing robot has strengthened the dimension of data attribution computing. In view of the increasingly complex Internet ecological environment, researchers from different fields are actively studying algorithms for detecting or identifying “real people” and “robots”. The text feature recognition algorithm based on natural language is the most commonly used method at present. However, due to the large scale and fast spread of Internet data, and the complexity of natural language feature calculation, no more effective data attribution feature calculation strategy has been found, except for measuring the network scale, identifying keyword features, classifying and counting the part-of-speech features and emotional features of natural language, and feature calculation methods of machine learning, which brings difficulties to Internet information service and data management. In order to enable machines to automatically determine the attribution characteristics of data information through the glyph features just like people, three researchers, Brenden M. Lake1, Ruslan Salakhutdinov and Joshua B, from Massachusetts Institute of Technology, New York University and Toronto University respectively, published a research achievement in the American journal Science, which opened an example of learning from a few concepts. A computer system that “may write only by looking at it” is developed and passed the visual Turing test. The emergence of this achievement has brought good news to the automated management of big data. Perhaps in the future, machines may be used to calculate the attribution of data according to different characters.

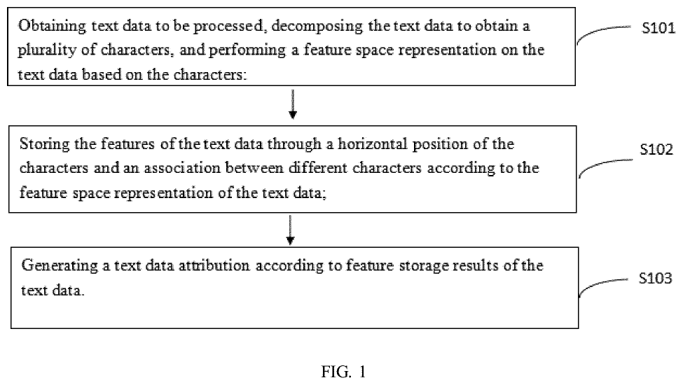

With reference to FIG. 1, this embodiment provides a text data attribution description and generation method based on text character features, including:

S101, obtaining text data to be processed, decomposing the text data to obtain a plurality of characters, and performing a feature space representation on the text data based on the characters;

In this step, the method for decomposing the text data to obtain a plurality of characters includes:

The text data is decomposed into single words, and then the single words are decomposed into Chinese character structures, and then each character in the text data is represented by the position function of character feature points. The main objective is to quantify the data attribution.

As an alternative scheme, in this embodiment, the method of representing the text data in feature space based on the characters includes:

Suppose the text data has Q fields, where the qth field is the text content, the (q−1)th field is the title of the text, and the (q−2)th field is the text author or attribution user. Then each character in the qth field of the text data may be expressed as a function with the field q, the character position i and the number of feature points j as variables, that is, the first feature point position function, as shown in formula (1):

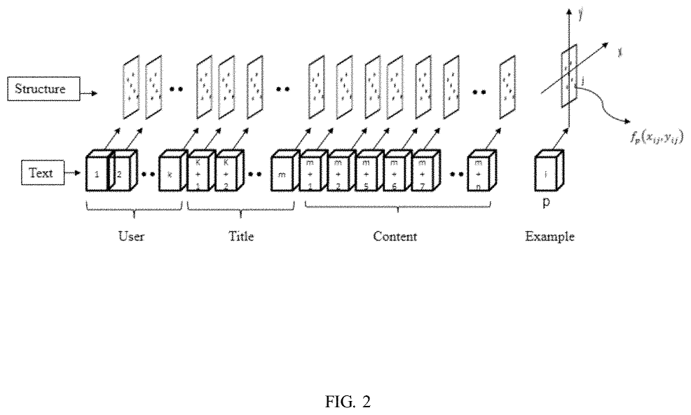

f_{q}(x_{y},y_{y})q∈Q (1)

where (x_{y}, y_{y}) is the position coordinate of the jth feature point of the ith character. The schematic feature space representation of each character is shown in FIG. 2.

Assuming that three fields (text content, text title, text author or attribution user) in the text data are arranged in sequence, each character in the text data containing all fields may be uniformly expressed as the second feature point position function as shown in formula (2):

f(x_{y},y_{y}) (2)

Since subscript I represents the position of characters and may be used to represent the number of characters, and j represents the number of feature points in each character, the feature space expression T of text data may be generated based on the second feature point position function as shown in formula (2), as shown in formula (3):

$$T = {⋃}_{i = 1}^{n} {⋃}_{j = 1}^{{m}_{i}} f ( {x}_{ij} , {y}_{ij} ) , \qquad ( 3 )$$

where the union

$${⋃}_{j = 1}^{{m}_{i}}$$

of j from 1 to mᵢ represents the sum of the feature points of mᵢ in the feature space of the ith character; n represents the number of characters in the text data; when the number n of characters in the text data tends to infinity, the feature space expression T′ of the text data is as follows:

$${T}^{′} = {lim}_{n \to ∞} {⋃}_{i = 1}^{n} {⋃}_{j = 1}^{{m}_{i}} f ( {x}_{ij} , {y}_{ij} ) , \qquad ( 4 )$$

It shows that the number of Chinese characters or characters tends to be infinite, therefore, expression (4) faithfully describes the feature space of current big data text data, and expression (4) is called the feature space expression of text data; since expressions (3) and (4) are descriptions of the characteristic points formed by characters, the above expressions (3) and (4) are suitable for all characters including Chinese characters, English letters or numbers.

According to the feature space representation of the text data, the feature value of the text data may be calculated;

In this step, the calculation of the characteristic value of the text data is shown in formula (5):

$${\sum }_{i = 1}^{n} {\sum }_{j = 1}^{{m}_{i}} f ( {x}_{ij} , {y}_{ij} ) ; \qquad ( 5 )$$

Expression (5) represents the sum of feature point distances of n characters. When n tends to infinity, it may represent the feature value of big data text.

S102, storing the features of the text data through a horizontal position of the characters and an association between different characters according to the feature space representation of the text data;

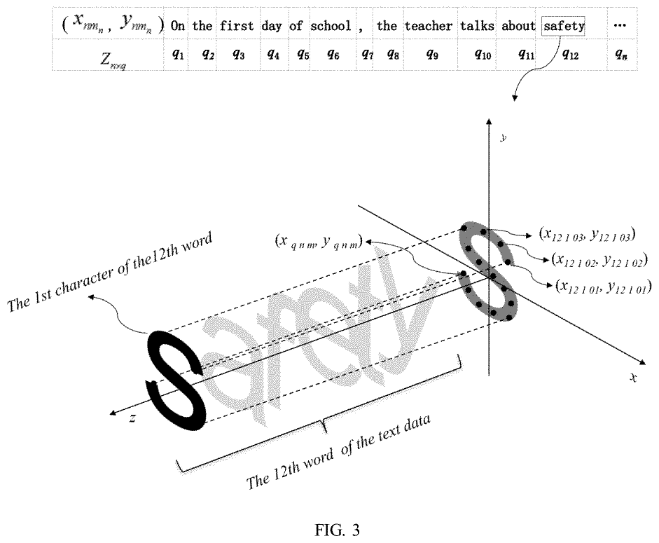

in this step, the process of storing the features of the text data includes: storing the feature space T of the text data in the form of X matrix, Y matrix and Z matrix, as shown in FIG. 3; wherein the X matrix and the Y matrix are used to determine the horizontal position of characters, and the Z matrix is used to determine the association between characters; specifically, the X matrix is used to store the x coordinates of each character in the text data, the Y matrix is used to store the y coordinates of each character in the text data, and the Z matrix is used to store the association between characters in the text data, for example, the association of “safety” in the text data, that is, the z axis in FIG. 3.

The matrix X is shown in formula (6):

$${X}_{n \times m} = [ \begin{matrix}{x}_{11} , {x}_{12} , ⋯ , {x}_{1 k} , ⋯ , {x}_{1 {m}_{1}} \\ {x}_{21} , {x}_{22} , ⋯ , {x}_{2 k} , ⋯ , {x}_{2 {m}_{2}} \\ ⋯⋯⋯⋯⋯⋯⋯⋯⋯ \\ {x}_{n 1} , {x}_{n 2} , ⋯ , {x}_{nk} , ⋯ , {x}_{{nm}_{n}}\end{matrix} ] , \qquad ( 6 )$$

that is, any group of data in the feature space T, the abscissa x of the feature points corresponding to its characters may form a matrix. The first row in the matrix represents the x coordinates of the mᵢ feature points of the first character of the text data, and the last row is the x coordinates of the mₙ feature points describing the last character of the text data. This matrix is called the x matrix of the feature space T.

The matrix Y is shown in formula (7):

$${Y}_{n \times m} = [ \begin{matrix}{y}_{11} , {y}_{12} , ⋯ , {y}_{1 k} , ⋯ , {y}_{1 {m}_{1}} \\ {y}_{21} , {y}_{22} , ⋯ , {y}_{2 k} , ⋯ , {y}_{2 {m}_{2}} \\ ⋯⋯⋯⋯⋯⋯⋯⋯⋯ \\ {y}_{n 1} , {y}_{n 2} , ⋯ , {y}_{nk} , ⋯ , {y}_{{nm}_{n}}\end{matrix} ] , \qquad ( 7 )$$

the first row in the matrix represents the y coordinates of mᵢ feature points of the first character of text data, and the last row is the y coordinates of mₙ feature points describing the last character of text data. This matrix is called the Y matrix of feature space T.

Because the number of feature points of each Chinese character is different, the value of the number of feature points of each character in X matrix and Y matrix may refer to the maximum value of all feature points, and the insufficient feature points are filled with 0.

The matrix Z is shown in formula (8):

Z_{n×q}=[z₁,z₂, . . . ,z_{q}] (8)

where n is the number of characters in the text data, q is the qth field in the text data, and z_{q} is the association between characters in the qth field.

S103, generating the text data attribution according to the feature storage result of the text data;

In this step, text data attribution is generated according to the X matrix, Y matrix, Z matrix and feature vectors on x axis, y axis and z axis, as shown in formula (9):

[symbol]

(x_{y},y_{y})=X_{n×m}\vec{i}+Y_{n×m}\vec{j}+Z_{n×q}\vec{k} (9),

where [symbol] (x_{y}, y_{y}) is the text data attribution, and \vec{i}, \vec{j} and \vec{k} are the feature vectors of coordinate axes corresponding to X matrix, Y matrix and Z matrix, respectively. \vec{i}, \vec{j} and \vec{k} three feature vectors are respectively determined by the text character features involved in the calculation, and the main objective is to constrain the complexity of the text data attribution calculation through the combination of these three feature vectors.

In order to further verify the effectiveness of the text data attribution description and generation method based on the text character features of the present application, the following text data attribution quantification experiment is conducted through a specific example.

In this embodiment, a data news of People's Daily is taken as an example to illustrate the feature calculation by using the feature point position function. Suppose the news has three fields, the first field indicates that the news belongs to People's Daily, the second field indicates the news headline “The 70th Anniversary of China”, and the third field indicates the news content “The Morning of October 1st, Beijing Time”.

According to formula (1), the characters in news content are represented in feature space in sequence, and the position functions corresponding to each character are as follows:

f₃(x₁ⱼ,y₁ⱼ)={B};

f₃(x₂ⱼ,y₂ⱼ)={e};

f₃(x₃ⱼ,y₃ⱼ)={i};

f₃(x₄ⱼ,y₄ⱼ)={j};

f₃(x₅ⱼ,y₅ⱼ)={i};

f₃(x₆ⱼ,y₆ⱼ)={n};

f₃(x₇ⱼ,y₇ⱼ)={g};

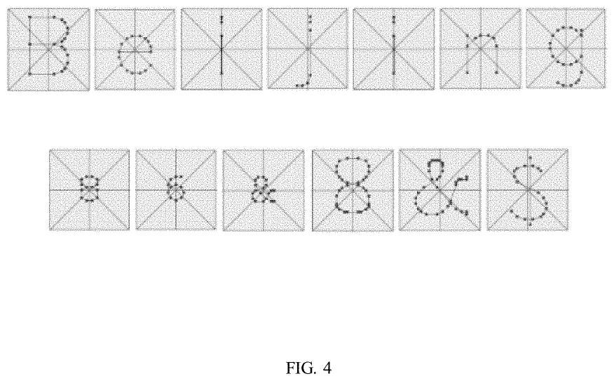

In order to obtain the text description data expression of position function, it is necessary to abstract the structure of each Chinese character and character, and the abstracted data feature points may be represented by the position function. According to the Chinese character description method, the pinyin initials B of the first word “Beijing” in the third field of the text content. may be described by 21 feature points. Of course, other characters such as numbers or letters may be described by this description method. As shown in FIG. 4, it is an example of abstract structure description of uppercase and lowercase letters, numbers and other characters.

For example, the characteristic points of the letter “B” are described as follows:

$$U ( J = 1 -> 21 ) ( {f}_{3} ( {x}_{1 j} , {y}_{1 j} ) == \{ < - 11 , 10 > < - 7 , - 12 > < - 7 , 9 > < - 7 , - 12 > < 5 , - 11 > < 6 , - 10 > < 7 , - 8 > < 7 , - 6 > < 6 , - 4 > < 5 , - 3 > < 2 , - 2 > < - 7 , - 2 > < 2 , - 2 > < 5 , - 1 > < 6 , 0 > < 7 , 2 > < 7 , 2 > < 6 , 7 > < 5 , 8 > < 2 , 9 > < - 7 , 9 > \} ,$$

That is, f₃(x_{1 1}, y_{1 1})=<−11,10>, f₃ (X_{1 2}, y_{1 2})=<−7, −12>, . . . , f₃(x_{1 21}, y_{1 21})=<−7,9>.

If f₁, f₂, f₃ sum are implemented in the model described in Expression (9), the final generated feature data will include all attributes of the whole text such as user data, title data and content data.

The above-mentioned embodiments only describe the preferred mode of this application, but do not limit the scope of this application. On the premise of not departing from the design spirit of this application, all kinds of modifications and improvements made by ordinary technicians in this field to the technical scheme of this application should fall within the scope of protection determined by the claims of this application.

What is claimed is:

1. A text data attribution description and generation method based on text character features, comprising:
obtaining text data to be processed, decomposing the text data to obtain a plurality of characters, and performing a feature space representation on the text data based on the characters;
storing the features of the text data through a horizontal position of the characters and an association between different characters according to the feature space representation of the text data; and
generating a text data attribution according to feature storage results of the text data;
wherein a method for performing the feature space representation on the text data based on the characters comprises following steps:
representing each character in the text data as a function with a field, a character position and a number of feature points as variables, a first feature point position function;
obtaining a second feature point position function of each character in the whole text data according to the feature point position function of each character; and
performing feature space representation according to the second feature point position function;
wherein the feature storage of the text data comprises:
storing feature space T of the text data in a form of X matrix, Y matrix and Z matrix; wherein the X matrix and the Y matrix are used to determine horizontal positions of characters, and the Z matrix is used to determine association between characters; and
wherein a method of generating the text data attribution comprises:
generating the text data attribution according to the X matrix, Y matrix, Z matrix and feature vectors of coordinate axes corresponding to the X matrix, Y matrix and Z matrix.

2. The text data attribution description and generation method based on text character features according to claim 1, wherein the first feature point position function, the second feature point position function and the feature space T representation of the text data are respectively shown in Formulas 1-3:
$$\begin{matrix}{f}_{q} ( {x}_{ij} , {y}_{ij} ) q ∈ Q & 1 \\ f ( {x}_{ij} , {y}_{ij} ) & 2 \\ T = {⋃}_{i = 1}^{n} {⋃}_{j = 1}^{{m}_{i}} f ( {x}_{ij} , {y}_{ij} ) & 3\end{matrix}$$
wherein (x_{y}, y_{y}) is position coordinates of the jth feature point of the ith character, Q is a number of fields in the text data, n is a number of characters in the text data, and mᵢ the number of feature points of the ith character; and a union set
$${⋃}_{j = 1}^{{m}_{i}}$$
of j from 1 to mᵢ represents a sum of mᵢ feature points in feature space of the ith character.

3. The text data attribution description and generation method based on text character features according to claim 2, wherein when a number n of characters in the text data tends to be infinitive, the feature space expression T′ of the text data is shown in Formula 4:
$${T}^{′} = {lim}_{n \to ∞} {⋃}_{i = 1}^{n} {⋃}_{j = 1}^{{m}_{i}} f ( {x}_{ij} , {y}_{ij} ) \qquad 4$$
wherein T′ is used to represent feature space of text data of big data.

4. The text data attribution description and generation method based on text character features according to claim 1, wherein X matrix X_{n×m} is used to store X coordinates of each character in the text data, as shown in Formula 6:
$${X}_{n \times m} = [ \begin{matrix}{x}_{11} , {x}_{12} , ⋯ , {x}_{1 k} , ⋯ , {x}_{1 {m}_{1}} \\ {x}_{21} , {x}_{22} , ⋯ , {x}_{2 k} , ⋯ , {x}_{2 {m}_{2}} \\ ⋯⋯⋯⋯⋯⋯⋯⋯⋯ \\ {x}_{n 1} , {x}_{n 2} , ⋯ , {x}_{nk} , ⋯ , {x}_{{nm}_{n}}\end{matrix} ] \qquad 6$$
Y matrix Y_{n×m} is used to store y coordinates of each character in the text data as shown in Formula 7:
$${Y}_{n \times m} = [ \begin{matrix}{y}_{11} , {y}_{12} , ⋯ , {y}_{1 k} , ⋯ , {y}_{1 {m}_{1}} \\ {y}_{21} , {y}_{22} , ⋯ , {y}_{2 k} , ⋯ , {y}_{2 {m}_{2}} \\ ⋯⋯⋯⋯⋯⋯⋯⋯⋯ \\ {y}_{n 1} , {y}_{n 2} , ⋯ , {y}_{nk} , ⋯ , {y}_{{nm}_{n}}\end{matrix} ] \qquad 7$$
Z matrix Z_{n×q} is used to store associations between characters of the text data, as shown in Formula 8:
Z_{n×q}=[z₁,z₂, . . . ,z_{q}] 8
wherein xₙₘ_{ₙ} and yₙₘ_{ₙ} are respectively the x coordinate and y coordinate of the mₙth feature point of the nth character in the text data; n is the number of characters in the text data; q is a qth field in the text data; z_{q} is the association between characters in the qth field.

5. The text data attribution description and generation method based on text character features according to claim 1, wherein the generated text data attribution is shown in Formula 9: [symbol]
(x_{y},y_{y})=X_{n×m}\vec{i}+Y_{n×m}\vec{j}+Z_{n×q}\vec{k} 9
wherein [symbol] (x_{y}, y_{y}) is attribution of text data, and \vec{i}, \vec{j} and \vec{k} are feature vectors of coordinate axes corresponding to X matrix, Y matrix and Z matrix respectively.
